(19) United States
(12) Patent Application Publication
(10) Pub. No.: US 2005/0163390 A1
(43) Pub. Date: Jul. 28, 2005

(54) Method for improving the depth of field and resolution of microscopy

(76) Inventor: Ann-Shyn Chiang, Hsinchu City (TW)

Correspondence Address: RUBEN C. DELEON;WINSTEAD SECHROST & MINICK P.C., P.O. BOX 50784, DALLAS, TX, 75201, US

(21) Appl. No.: 10/764,091

(22) Filed: Jan. 23, 2004

(51) Int. Cl. G06K 9/40

(52) U.S. Cl. 382/254

(57) ABSTRACT

This invention is about a microscopic technology for improving depth of field and resolution by obverse and opposite scanning and 3D image combination. According to the above-mentioned design, the thickness of the three-dimensional image can be increased, and the image resolution and the depth of field can be improved. After fixing a sample in 3D space with embedding gel, the obverse and opposite scanning are performed to the sample, and the images obtained from the mentioned scanning are combined to achieve the 3D microscopic image with the deeper depth of field. The mentioned 3D image combination comprises the application of fast Fourier Transferring, Sobel edge checking, and relative matching to determine the overlapping position of the obverse and the opposite scanning images on Z axial. After finding out the shift on X Y plane and the rotation pivoted with Z axial by fast Fourier Transferring theory, the upper and the lower images are adjusted, and a complete 3D image is achieved.

### BACKGROUND OF THE INVENTION

1. Field of the Invention

This present invention relates to a method of microscopy, and more particularly, to a method for improving the depth of field and resolution of microscopy by performing the obverse and opposite scanning and combining the images.

2. Description of the Prior Art

Confocal microscopy in the prior art can achieve high-resolution microscopic image of sample in different depth by removing the noise from non-focus plane. The above-mentioned method comprises the following steps. First, a laser is focused to a single radiant with an object lens, and the radiant is employed to irradiate to a specific depth of a sample. Then, the light reflected or dispersed from the focus radiant can be focused to a single beam by the same object lens, and completely pass through the pinhole aperture in front of an image detector. Finally, the other photons, above or bellow the focus, are blocked by the surroundings of the mentioned pinhole aperture. Therefore, the accuracy of the detector for catching the focus image can be ensured, and the high-resolution microscopic image of different depth can be obtained by the above-mentioned design, as shown in FIG. 1. Hence, if the pinhole aperture becomes smaller, more noise can be removed in that system, and the obtained image is more clear and concentrated.

Comparing confocal microscope with the traditional microscope, the former one obviously comprises more advantages than the latter. In traditional microscope, when observing the image of a thick organism in Z coordination, the research is limited to the focus range of the depth of field of the object lens used therein. If the size of the observed target were over the range, the light of the focus plane would be seriously interfered with the light out of the focus plane. Thus, the contrast of the obtained image is decreased, and the obtained image becomes blurred. Moreover, if the observed sample radiating many kinds of fluorescence from itself, every single hunted image of the observed sample is mixed with other fluorescence noises. However, confocal microscope is design for observing thick fluorescence sample, such as organism tissue. The non-focus noise, which cannot be removed by traditional microscope, can be efficiently decreased by the function of optics section of confocal microscope. For the sample with multiple fluorescences, the fluorescence messages from different spectrum ranges can be exactly separated by confocal microscope, and the clear microscopic images in different depth of a thick organism tissue can be obtained.

Today, there are two ways for improving the depth of field in microscopic detection. One is employing two microscopes disposed at the obverse side and the opposite side of the sample. After calculating the relative positions, the conjugated images can be obtained from the obverse side and the opposite side of the sample. The obtained image is about twice as thick as the image from a single microscope. However, the above-mentioned design will increase the cost of the hardware very much. The other way for increasing the depth of field is using the technology of multiple photons microscopy to achieve the purpose. Of course, the second way will also increase the hard ware cost.

Hence, for improving the image resolution of sample and obtaining deeper three-dimensional image, it is an important object to provide a method for improving the depth of field and resolution of microscopy.

### SUMMARY OF THE INVENTION

In accordance with the present invention, a method for improving the depth of field and resolution of microscopy is provided. According to this invention, the 3D image of a sample with deeper thickness can be obtained by performing the obverse and the opposite scan to the sample.

It is another object of this invention to provide a method for improving the depth of field and resolution of microscopy. The method of this present invention can improve the depth of field and resolution by combining the obverse and the opposite scanning images of a sample.

It is still another object of this invention to provide a method for improving the depth of field and resolution of microscopy. According to the above-mentioned design, the preparation before performing microscopic scanning can be simplified by reducing the number of cut pieces of the observed sample.

In accordance with the above-mentioned objects, the invention provides a method for improving the depth of field and resolution of microscopy. The above-mentioned method at least comprises the following steps: fixing a sample in three-dimensional space with embedding gel, performing the obverse scanning and the opposite scanning to the sample, finding out the overlapping position of the obverse and the opposite scanning images on Z axial, using the image of the overlapping area on Z axial to adjust the opposite scanning images, wherein the adjustment is referred to the obverse scanning images, and combining the obverse and the opposite scanning images to obtain a complete three-dimensional image. According to this invention, the depth of field can be increased, and thus the resolution of the microscopic image can be improved. Moreover, the thickness of the three-dimensional image obtained by the above-mentioned design is thicker than the image obtained by the method in the prior art. More preferably, the sample can be cut into fewer pieces for performing the microscopic scanning of this invention. That is, according to the above-mentioned design, the preparing procedures before performing microscopic scanning is more easier than that in the prior art.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows employing a laser through an object lens focused into a single radiant for irradiating to the specific depth of a sample according to this invention;

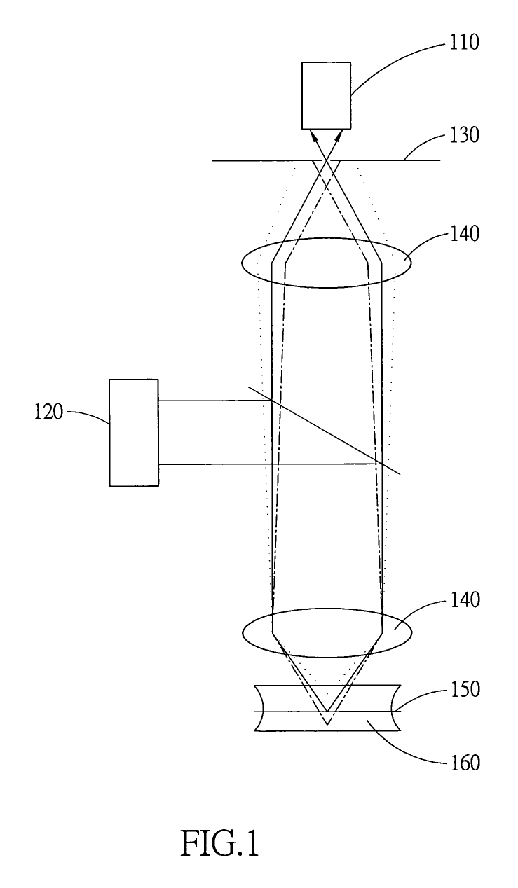

FIG. 2 shows an obverse scanning image and an opposite scanning image according to this presented invention;

FIG. 3 shows a flow chart of combining the microscopic obverse scanning image and the microscopic opposite scanning image according to this invention;

FIG. 4 shows a flow chart of Fourier's Transferring process of this invention;

FIG. 5A shows an image after an edge checking process;

FIG. 5B shows the gradient strength image of FIG. 5A after using Sobel operation to perform edge checking;

FIG. 5C shows the image with obvious edge change area of image f after using Sobel operation to perform edge checking;

FIG. 6 shows the process of finding the area in image f most similar to the template w by relative coefficient of the relative matching method of this invention;

FIG. 7 shows a diagram of the position of the most protruding peak in the opposite scanning image according to this invention;

FIG. 8 shows a flow chart for ensuring the overlapping position on Z axial of an obverse and an opposite scanning images;

FIG. 9 shows a surface image of the obverse and the opposite scanning of an organism sample; and

FIG. 10 shows a complete three-dimensional image of an organism sample after combining the obverse and the opposite scanning images.

### DESCRIPTION OF THE PREFERRED EMBODIMENTS

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

Then, the components disclosed in this application are not shown to scale. Some dimensions are exaggerated to the related components to provide a more clear description and comprehension of the present invention.

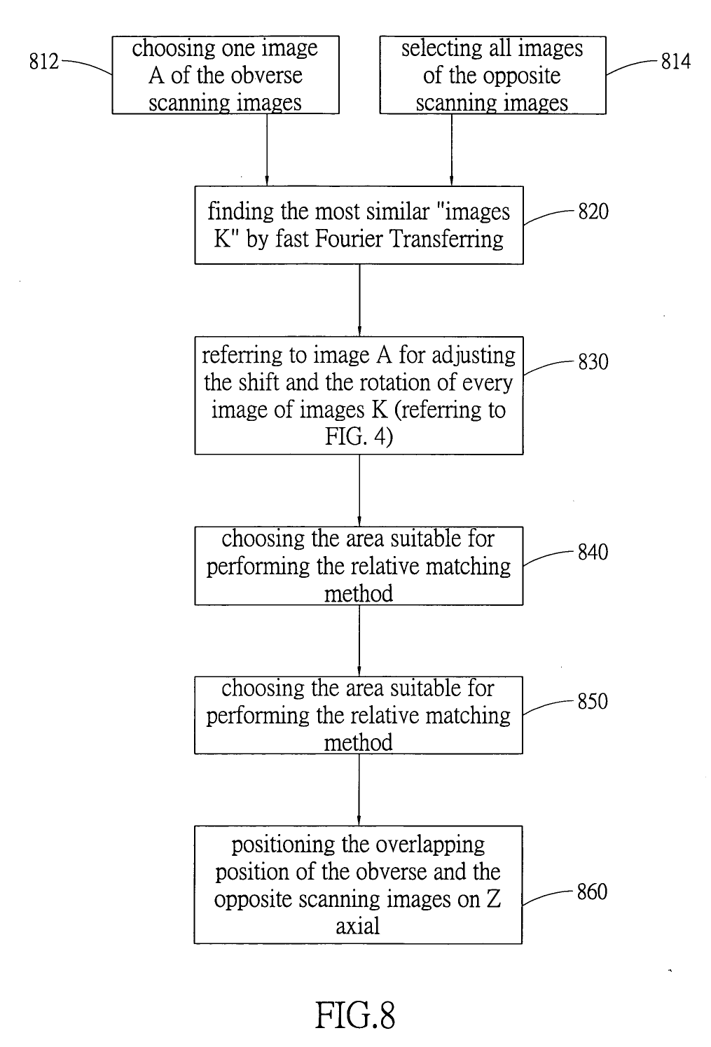

One preferred embodiment of this invention is a method for improving the depth of field and resolution of microscopy. According to this invention, in order to obtain the deeper three-dimensional image, the obverse side and the opposite side scanning images of a sample are taken. For the three-dimensional image, because the sample is fixed in sample embedding gel, the differences between the taken obverse and opposite images, before and after flipping, are the shift on X Y plane and the rotation pivoted with Z axial. The rotation of angle ψ in three-dimensional space will not happen. After finding the overlapping position on Z axial, each image is picked from the overlapping part before and after the flipping. The shift on X Y plane and the rotation pivoted with Z axial of the taken image before and after the flipping are calculated. Then, the obverse scanning images are used as the reference for adjusting the Z axial coordination, the shift on X Y plane, and the rotation pivoted with Z axial of the opposite scanning images. Thus, two series of continuous images can be obtained for building a complete three-dimensional image. The overlapping position on Z axial of the opposite scanning images can be ensured by using fast Fourier's Transferring theory to narrow down the wanted overlapping position range on Z axial, and using Sobel edge checking concept to find out the most edge variation area in the image. With a correlative matching method, the above-mentioned area can be used to determine the images in the opposite scanning images, wherein the images are most similar to the image A chosen from the obverse scanning images, and thus the overlapping position of the obverse and the opposite scanning images on Z axial is ensured, as shown in FIG. 8. After ensuring the overlapping position of the obverse and the opposite scanning images on Z axial, the shift on X and Y direction and the rotation on Z axial can be found out by Fourier's Transferring theory, and the position of the upper and the lower images can be adjusted. Thus, the obtained image will become a complete three-dimensional image.

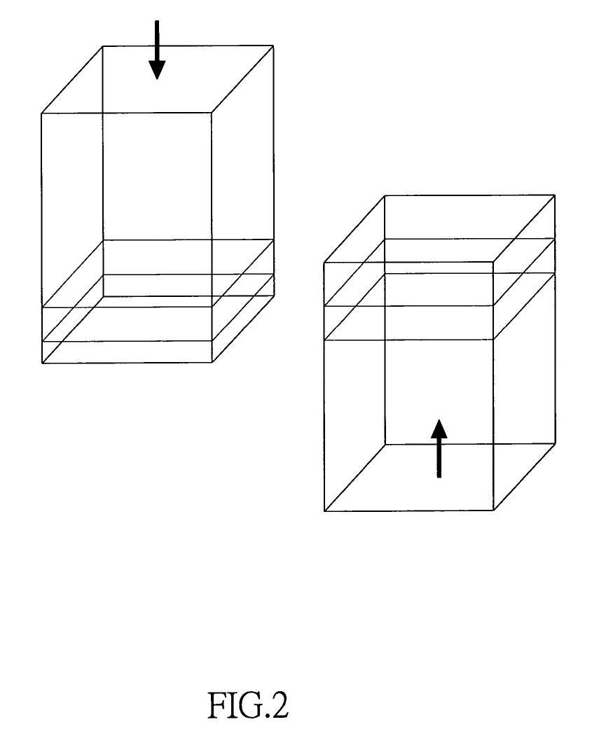

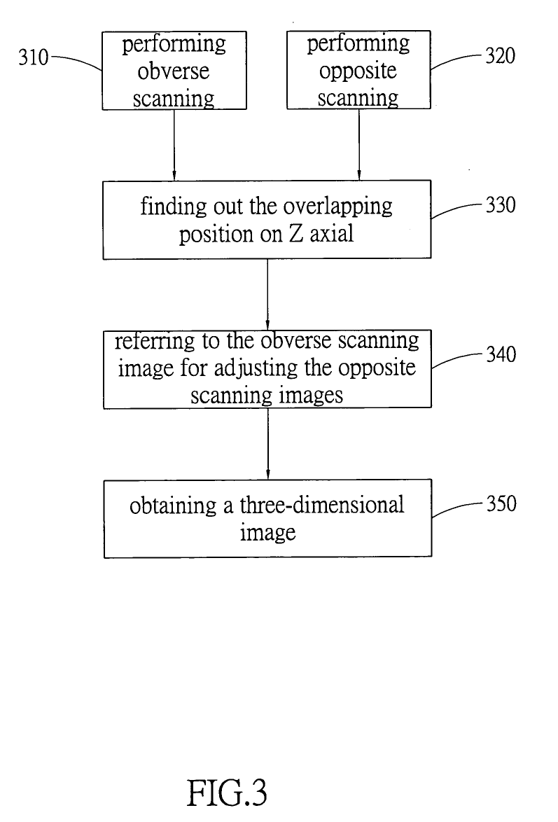

According to this invention, in order to obtain the deeper three-dimensional image, the obverse and the opposite scanning images of a sample are taken. Referring to FIG. 2, the bold rectangle flame line shows the overlapping area of the obverse and the opposite scanning images. Because the sample is fixed in three-dimensional space by embedding gel, the differences between the obverse and the opposite scanning image are the shift on X Y plane and the rotation pivoted with Z axial. After using the overlapping area of the obverse and the opposite scanning images to find out the overlapping position of the obverse and the opposite scanning images on Z axial and picking up each one image from the overlapping area of the obverse and the opposite scanning images, the shift on X Y plane and the rotation pivoted with Z axial of the obverse and the opposite scanning images can be calculated. Finally, referring to the obverse images, the Z axial coordination, the shift on X Y plane, and the rotation pivoted with Z axial of the opposite scanning images can be adjusted for obtaining a complete 3D image. The flow chart of the obverse and the opposite microscopic scanning images combination system is shown as FIG. 3.

The main technology and theory employed in this invention are described as following.

A. Fast Fourier Transferring for Combining Images

The Fourier Transferring phase relation is employed in fast Fourier Transferring for combining images. If there is only shift between two images, such as the image f₂ is the image f₁ after shifting (x₀, y₀), the relation of the images is shown as the equation (1).

After performing Fourier Transferring, the equation (1) becomes the equation (2). The shifting relation between the equations (1) and (2) only occurs in the phase element e^{-j2π(ξx}^{₀}^{+ηy}^{₀}⁾.
f₂(x,y)=f₁(x−x₀,y−y₀) (1)
F₂(ξ,η)=e^{-j2π(εx}^{₀}^{+ηy}^{₀}⁾ (2)

The phase element can be achieved by the equation (3), wherein F* is conjugate with F.

After performing anti-Fourier Transferring to the phase element e^{-j2π(εx}^{₀}^{+ηy}^{₀}⁾, from the calculating result of anti-Fourier Transferring, (x₀, y₀) can be determined by the pulse position. The equation (4) shows the relation of Fourier Transferring and anti-Fourier Transferring.

$$\begin{matrix}\frac{{F}_{2} ( ξ , η ) {F}_{1}^{*} ( ξ , η )}{\vert {F}_{2} ( ξ , η ) {F}_{1}^{*} ( ξ , η ) \vert} = {ⅇ}^{- j 2 π ( ξ {x}_{0} + η {y}_{0} )} & ( 3 ) \\ δ ( x - {x}_{0} , y - {y}_{0} ) ⇔ {ⅇ}^{- j2π ( ξ {x}_{0} + η {y}_{0} )} & ( 4 )\end{matrix}$$

When rotating and shifting appears in two images at the same time, the relation thereof is shown as the following equation (5).
f₂(x,y)=f₁(xcos θ₀+ysin θ₀−x₀,−xsin θ₀+ycos θ₀−y) (5)

After performing fast Fourier Transferring to equation (5), the relative relation of the two images is as the equation (6).
F₂(ξ,η)=e^{-j2π(ξx}^{₀}^{+ηy}^{₀}⁾×F₁(ξ cos θ₀+η sin θ₀,−ξ sin θ₀+η cos θ₀) (6)

The amplitudes M₁ and M₂ of the equation (6) are taken as the equation (7), wherein M₁ and M₂ are the amplitudes of F₁ and F₂. In the equation (7), M₂ is the result of rotating M₁ in θ₀. After transforming the polar coordination of M₁ and M₂, the equation (8) is produced as the following.
M₂(ξ,η)=M₁(ξ cos θ₀+η sin θ₀,−ξ sin θ₀+η cos θ₀) (7)
M₁(ρ,θ)=M₁(ρ,θ−θ₀) (8)

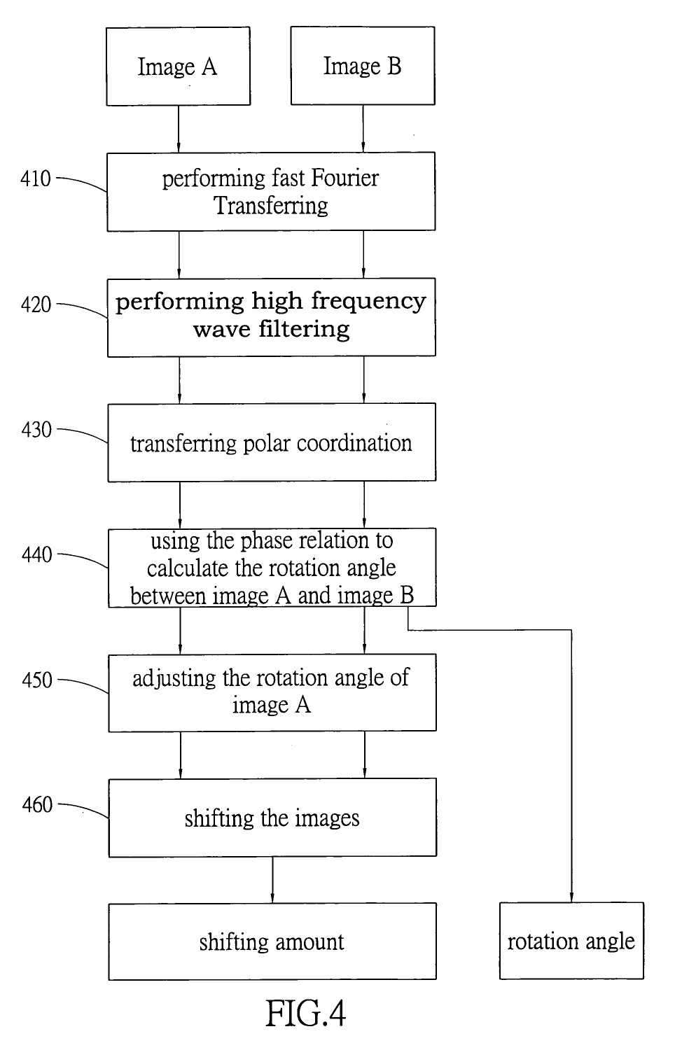

In the equation (8), M₁ and M₂ becomes shifting relation, and the shifting amount is θ₀. θ₀ can be found out by the above-mentioned phase relation of Fourier Transferring. Subsequently, after rotating f₁ in θ₀ to get fᵢ′, the relationship between f₁′ and f₂ is only shift. Then, according to the phase relation of Fourier Transferring, (x₀, y₀) can be achieved. All the above-mentioned process can be referred to FIG. 4. After performing Fourier Transferring, the high frequency portion of the image comprises the important character of the original picture. Therefore, before transforming the polar coordination, a high frequency wave filter is added for raising the accuracy of the angle evaluation. The formation is shown as the flowing equation (9), wherein D₀=0.3.

$$H ( u , v ) = \{ \begin{matrix}0 if & D ( u , v ) \leq {D}_{0} \\ 1 if & D ( u , v ) > {D}_{0}\end{matrix} \qquad ( 9 )$$

B. Sobel Edge Checking

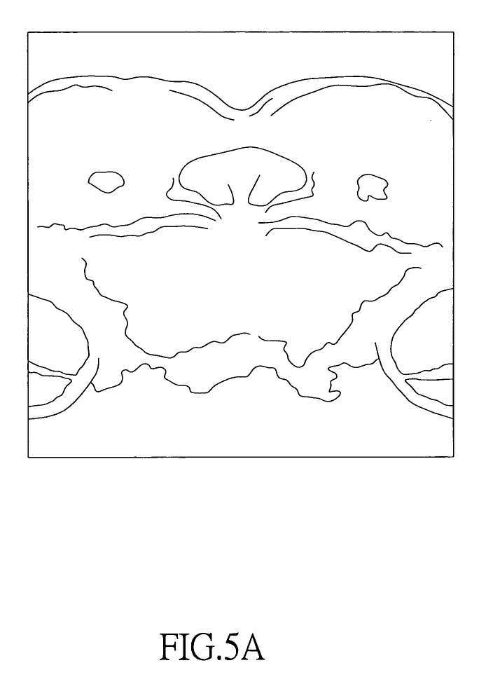

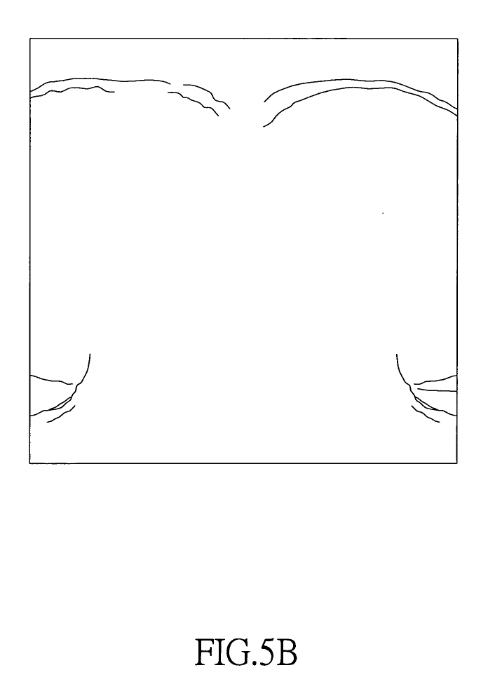

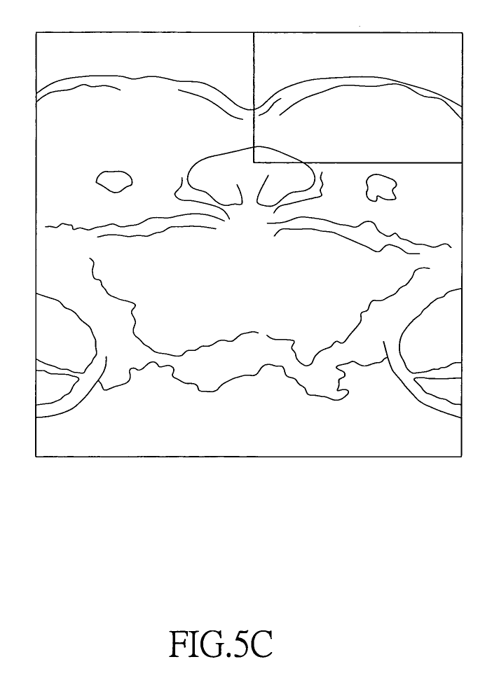

Sobel calculating element is employed in this presented invention for the edge checking. After employing Sobel calculating element for the edge checking for the image f every pixel on image f can get a gradient strength |∇f|. FIG. 5B shows the gradient strength image of FIG. 5A after the edge checking with Sobel calculating element. Referring to the image in FIG. 5B, if the gradient strength of a portion is stronger, wherein the portion is brighter in the image, the portion is a more obvious edge. That is, in the image, if the brightness variation were clearer, the portion would comprise the more obvious edge. In this invention, the gradient strength image of the image f after the edge checking is employed for finding out the obvious edge variation area in the image f. After setting a proper size block, a position with the biggest sum of |∇f| of the block in the gradient strength diagram of the image f can be found out. The mentioned position is the obvious edge varying area in the image f, as shown in FIG. 5C. The area is used as a template to show the difference between the other images waiting for comparison and the template. The above-mentioned comparison is for the following relative matching process.

C. Relative Matching

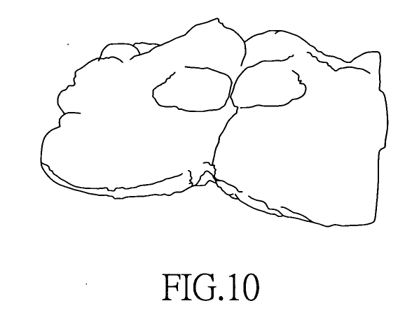

By the relative coefficient r(s, t) from the relative matching method, as shown in FIG. 10, the most similar area to the template w can be found in the image f. The relative coefficient r(s, t) can be achieved by removing the template w(x, y) in the M×N image f(x, y) from left to right and from up to down and employing the equation (10), wherein s=0, 1, 2, . . . M−1; t=0, 1, 2, . . . N−1. T shows the overlapping area of the image f and the template w. That is, the equation (2-1) is only performed in the overlapping area. \overline{f}(x,y) shows the brightness average value of the overlapping area of the image f and the template w. \overline{w} shows the brightness average value of the template w.

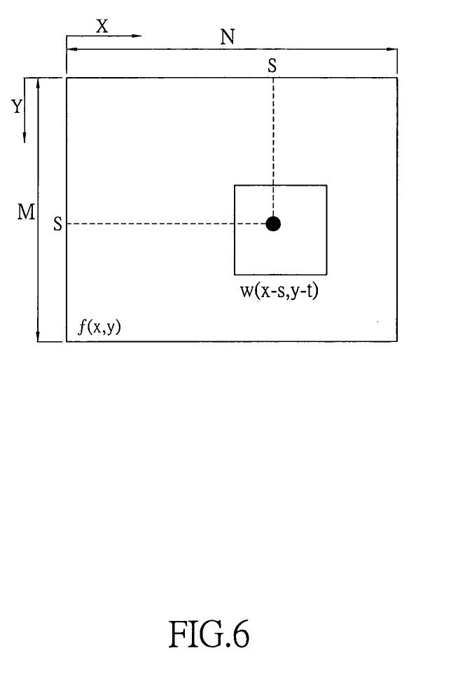

As shown in FIG. 6, the origin of f(x, y) is at the left upper corner, and the origin of w(x, y) is at its center. Any position (s, t) in f(x, y) can get a relative coefficient r(s, t) from the equation (10). The position with the highest similarity thereof is the area which is most similar to w(x, y). The evaluating range of r(s, t) is −1≦r(s, t)≦1.

$$r ( s , t ) = \frac{{\sum }_{xy ∈ T} \sum [ f ( x , y ) - \overline{f} ( x , y ) ] [ w ( x - s , y - t ) - \overline{w} ]}{{\{ {\sum }_{xy ∈ T} \sum {[ f ( x , y ) - \overline{f} ( x , y ) ]}^{2} {\sum }_{xy ∈ T} \sum {[ w ( x - s , y - t ) - \overline{w} ]}^{2} \}}^{1 / 2}} \qquad ( 10 )$$

D. Ensuring the Overlapping Position of the Obverse and the Opposite Scanning Images on Z Axial

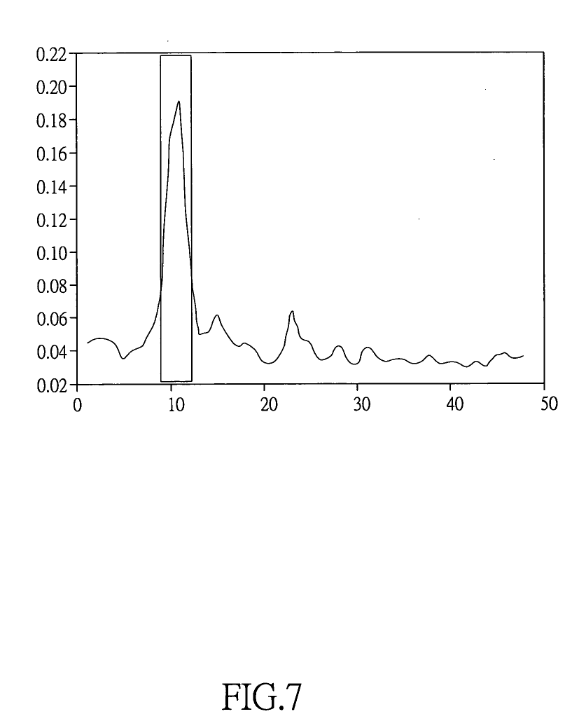

Ensuring the overlapping position on Z axial is to find out the similar images in two images for ensuring the position of the overlapping area. The first step thereof is employing the peak in the mentioned fast Fourier Transferring calculation of the rotation of two images to determine the position. When the difference between two similar images, such as the image A and the image B are similar, is rotation and shift, the obtained peak is higher than the peak of performing the same calculation of replacing the image B to the image C, wherein the image C is not similar to the image A. In the opposite scanning images, the images similar to the obverse scanning the image A are near the most protruding peak. Referring to FIG. 7, the most protruding peak is in the bold rectangle flame. Therefore, those images similar to the image A are in the surrounding of the eleventh section. In the following, those images are called “images K” for easily description. Through the above-mentioned concept, the rough overlapping position on Z axial can be positioned, and the compared pieces of the image can be reduced. Thus, the following calculating amount can be simplified. However, all of the images may be the image in the opposite scanning images most similar to the obverse scanning image A. After calculating the shift on X Y plane and the rotation pivoted with Z axial of every image of the images K chosen from the opposite scanning image and the image A, adjusting the shifting amount and rotation angle, using the mentioned Sobel edge checking concept to find the most edge varying area, and using the relative matching theory to determine the image in the opposite scanning images most similar to the obverse scanning image A, the overlapping position of the obverse and the opposite scanning images on Z axial can be found out, as shown in FIG. 8. Finally, after determining the overlapping position on Z axial, two images, chosen from each of the obverse and the opposite scanning images, are picked from the overlapping area of the obverse and the opposite scanning images. The shift on X Y plane and the rotation pivoted with Z axial of the picked images are calculated. Taking the obverse scanning image as the reference, the Z axial coordination, the shift amount on X Y plane, and the rotation pivoted with Z axial are adjusted.

### First Embodiment

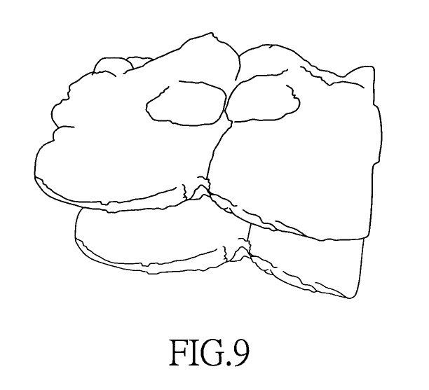

FIG. 9 shows the surface spectrums of the obverse and the opposite scanning images. Picking the lowest of the obverse scanning images and every of the opposite scanning images, the rough position of the lowest of the obverse scanning images relative to the opposite scanning images on Z axial can be determined by using fast Fourier Transferring to calculate the peaks during rotating the two images, as shown in FIG. 7. Then, by the mentioned Sobel edge checking concept, the portion with larger edge variation, such as the rectangle flame with bold lines in FIG. 5C, can be found out. Using the above-mentioned portion and the relative matching method, the image in the opposite scanning images most similar to the image A in the obverse scanning images can be found, and the overlapping position of the obverse and the opposite scanning images on Z axial can be determined. The flow chart for determining the overlapping position on Z axial is shown as FIG. 8. After determining the overlapping position on Z axial, two images are chosen for the next step, wherein one image of the two images is chosen from the obverse scanning image of the overlapping position of the obverse and the opposite scanning images, and the other one is chosen from the opposite scanning image of the overlapping position of the obverse and the opposite scanning image. The shift on X Y plane and the rotation pivoted with Z axial of the picked images are calculated, as shown in FIG. 4. Then, the Z axial coordination, the shift amount on X Y plan, and the rotation pivoted with Z axial are adjusted by taking the obverse scanning image as the reference. Thus, a complete 3D image is obtained. FIG. 10 shows a complete 3D image of the organism sample after performing image combination of the obverse and the opposite scanning images, wherein the thickness of the 3D image is about twice as thick as the obverse scanning image.

### Second Embodiment

The thickness of the cerebrum of a fly is about 160 μm. After marking the cranial nerve cells with green fluorescence protein and activating with a 488 nm laser, the complete three-dimensional image of the cerebrum can be taken. However, it is found that when the depth of the sample is deeper, the taken image by the laser becomes more blurred. That is cause by the light-absorption of the organism sample. The energy of the activated light or the emitted light is absorbed by the sample, and thus the taken three-dimensional image becomes very blurred under some depth. When employing the method of this invention, in order to obtain a complete and clear three-dimensional cerebrum image, it is only required to scan to a little deeper than the depth of the cerebrum for the obverse and the opposite scanning, and to combine the obtained images.

### Third Embodiment

Generally, in order to perform a confocal microscopic scanning, an organism tissue thin slice may be buried in glycerol for microscopic scanning and the following recording. By cooperating with the method of this invention, the thickness of the target organism tissue sample can be raised to about twice than the thickness of the organism tissue sample in the prior art. After embedding an organism tissue sample with sample embedding gel for fixing it in three-dimensional space, a complete and clear 3D organism image can be obtained by scanning the sample until the scanning depth a little deeper than the thickness of the sample for taking the obverse and the opposite scanning images and combining the above-mentioned scanning images. The thickness of the three-dimensional image obtained by the above-mentioned method is twice as thick as the thickness obtained by the sample buried in glycerol and scanned by the prior art method.

### Forth Embodiment

In general, in order to perform a confocal microscopic scanning, an organism tissue thin slice may be buried in glycerol for microscopic scanning and the following recording. When using FocusClear clarifying tissue and buried in MountClear™, the depth of field can be efficiently improved. If the above-mentioned design cooperating with the method of this invention, the thickness of the taken three-dimensional image can be improved once more, and twice as thick as the thickness of the method only employing FocusClear clarifying tissue and buried in MountClear™.

### Fifth Embodiment

In order to obtain whole image of a mouse's cerebrum, the cerebrum may be dealt with the vibration microtomy. In traditional, an about 4 mm thick cerebrum of an adult mouse may be cut into 100-200 pieces thin slices in about 10-20 μm at first, and buried in glycerol for microscopic scanning and recording. When using FocusClear clarifying tissue and buried in MountClear™, the scan-able thickness of the above-mentioned method can be raised to about 20 μm. If the above-mentioned method cooperating with the method of this invention, a clear image of a 400 μm thick sample can be obtained. According to this design, an adult mouse's cerebrum may only be cut into about 10 pieces in 400 μm thick for performing the scanning to obtain the images. Therefore, the method of this invention, not only the depth of field of the three dimensional image can be efficiently improved, but also the thick organism tissue, such as the cerebrum of an adult mouse, can be cut into fewer pieces for performing a microscopic scanning.

### Sixth Embodiment

When cooperating with multiple photon microscopy, three-dimensional images can be obtained by employing multiple photon microscope to take the obverse and the opposite scanning images and combining the above-mentioned scanning images. The thickness (depth of field) of the three-dimensional image obtained by the above-mentioned design is about twice as thick as the image obtained by only multiple photon microscopes. That is, in order to obtaining the complete images of a cerebrum of an adult mouse, it is only required to be cut into 5 pieces in 800 μm, bury the pieces in MountClear™, take the obverse and the opposite scanning images thereof, and combine the scanning images with the disclosure of this invention.

According to the preferred embodiments, this invention discloses a method for forming an anti-glaring and anti-reflecting film. The above-mentioned method comprises the steps of providing a substrate, and forming an anti-glaring and anti-reflecting layer on the substrate. The anti-glaring and anti-reflecting layer at least comprises a resin and a plurality of particles with the diameter about 200-300 nm. The constitution of the particles employed in this invention may comprise fluoride. According to this invention, the anti-glaring and anti-reflecting film can be produced by a single coating process for coating the mixture of the resin and the particles on the substrate. Therefore, this invention can efficiently simplify the manufacture of the anti-glaring and anti-reflecting film, and improve the yield of the anti-glaring and anti-reflecting film. Preferably, besides the functions of anti-glaring and anti-reflecting, the anti-glaring and anti-reflecting film of this invention further comprises the functions of anti-fouling and hard coating.

Although specific embodiments have been illustrated and described, it will be obvious to those skilled in the art that various modifications may be made without departing from what is intended to be limited solely by the appended claims.

1. A method for improving the depth of field and resolution of microscopy, comprising:
fixing a sample;
performing an obverse scanning and an opposite scanning to the sample for obtaining obverse scanning images and opposite scanning images;
adjusting the opposite scanning images by referring to the obverse scanning images; and
combining the obverse and the opposite scanning images to obtain a complete three-dimensional image.

2. The method according to claim 1, wherein the sample is fixed with embedding gel.

3. The method according to claim 2, wherein said adjusting the opposite scanning images by referring to the obverse scanning images step comprises:
choosing one image from the obverse scanning images;
comparing said image with every opposite scanning images;
employing fast Fourier Transferring theory for finding images of the opposite scanning images most similar to said image chosen from the obverse scanning image;
adjusting the relative shift and rotation of said images of the opposite scanning images most similar to said image chosen from the obverse scanning images;
choosing an area suitable for performing relative matching; and
positioning the overlapping position of the obverse scanning images and the opposite scanning images on Z axial.

4. The method according to claim 3, wherein said area for performing relative matching is chosen by Sobel edge checking concept.

5. The method according to claim 1, wherein said obverse scanning and said opposite scanning are performed with a multiple photon microscope.

6. The method according to claim 1, wherein said obverse scanning and said opposite scanning are performed with a confocal microscope.

7. The method according to claim 1, further comprising employing a single wavelength activated light during the obverse scanning and the opposite scanning.

8. The method according to claim 1, further comprising employing a multiple wavelength activated light during the obverse scanning and the opposite scanning.

9. A method for improving the depth of field and resolution of microscopy, comprising:
fixing a sample;
performing an obverse scanning and an opposite scanning to the sample for obtaining obverse scanning images and opposite scanning images;
choosing one image A from the obverse scanning images;
comparing said image with every opposite scanning images;
finding images K of the opposite scanning images most similar to said image A;
adjusting the relative shift and rotation of said images K;
positioning the overlapping position of the obverse scanning images and the opposite scanning images on Z axial; and
combining the obverse and the opposite scanning images to obtain a complete three-dimensional image.

10. The method according to claim 9, wherein the sample is fixed with embedding gel.

11. The method according to claim 9, wherein said images K are chosen with the fast Fourier Transferring theory.

12. The method according to claim 9, after adjusting the relative shift and rotation of said images K, further comprises a step of choosing an area suitable for performing relative matching.

13. The method according to claim 12, wherein said area for performing relative matching is chosen by Sobel edge checking concept.

14. The method according to claim 9, wherein the shift in said step of adjusting the relative shift and rotation of said image K is on X Y plane.

15. The method according to claim 9, wherein the rotation in said step of adjusting the relative shift and rotation of said image K is pivoted with Z axial.
